(19) United States
(12) Patent Application Publication
(10) Pub. No.: US 2017/0322637 A1
(43) Pub. Date: Nov. 9, 2017

(54) MOUSE ACTION CAPTURE AND REPLAY SYSTEM AND METHOD, RECORDING MEDIUM, AND PROGRAM PRODUCT

(71) Applicant: National Central University, Jhongli City (TW)

(72) Inventor: Yung-Pin Cheng, Jhongli City (TW)

(21) Appl. No.: 15/404,664

(22) Filed: Jan. 12, 2017

(30) Foreign Application Priority Data
May 9, 2016 (CN) 105114284

(51) Int. Cl. G06F 3/038; G06T 7/246; G06T 7/73; G06T 7/00; G06T 1/00; G06F 3/0354

(52) U.S. Cl. CPC G06F 3/038; G06T 1/0007; G06F 3/03543; G06T 7/74; G06T 7/97; G06T 7/248

(57) ABSTRACT

Disclosed is a mouse action capture and replay method, including the following steps: reading, by a capture and replay verification module, a mouse movement signal in a mouse action event file; transmitting, by the capture and replay verification module, the mouse movement signal to a system under test to which replay is applied; regularly sending, by the capture and replay verification module, an image capture signal to an image capture module, capturing, by the image capture module, a screenshot from the system under test to which replay is applied, and converting the screenshot to a screenshot image file to be transmitted to the capture and replay verification module; comparing, by the capture and replay verification module, an earlier captured screenshot image file with a later captured screenshot image file, so as to acquire a position of a cursor on a screen of the system under test to which replay is applied; and determining, by the capture and replay verification module according to the acquired position of the cursor, whether the cursor moves to a position corresponding to a designated image block or a specific cursor coordinate on the screen.

### BACKGROUND

### Technical Field

The present invention relates to the field of computer technologies, and in particular, to a mouse action capture and replay system and method, a recording medium, and a program product.

### Related Art

In a process of using or testing a computer system, keyboard and mouse operation manners can be regarded as main operation actions. In some application scenarios, for example, in test automation, a mouse action operated by a person always needs to be reproduced.

Using setting up a network as an example, boot a Window operating system, sign in, then wait for the completion of the boot of the operating system, then click “control panel”, then use a mouse to select “network and Internet”, then use the mouse to click “network and sharing center”, and finally, click “set up a new connection or network”. The series of actions require a user to move a mouse cursor to a particular position, to send a mouse click event, and then to perform a next step after waiting for a computer response.

If the foregoing setup of the network is used as a test for a computer system, operations need to be manually performed one step by step. Therefore, one tester can only check one computer system, an objective of automation cannot be achieved, and an objective of simultaneously testing multiple computers cannot be achieved.

### SUMMARY

In view of the foregoing problems, an objective of the present invention is to provide a mouse action capture and replay system and method, a recording medium, and a program product. With the present invention, no mouse event blocking software needs to be installed on a system under test; by means of capture and replay technologies, a test engineer can capture a whole mouse operation action to form an event file, and mouse operation actions are executed one by one, in a manner of replaying data of the mouse operation actions in the event file, on the system under test; and a tester does not need to manually operate the mouse step by step, so as to achieve the objective of automation and the objective of simultaneously testing multiple computers.

According to a first aspect of the present invention, a mouse action capture and replay method is provided, including the following steps:

reading, by a capture and replay verification module, a mouse action event file, where the mouse action event file includes a designated image block or a specific cursor coordinate;

transmitting, by the capture and replay verification module by using a Universal Serial Bus (USB) emulator, a mouse movement signal to a system under test to which replay is applied;

regularly sending, by the capture and replay verification module, an image capture signal to an image capture module, capturing, by the image capture module, a screenshot from the system under test to which replay is applied, and converting the screenshot to a screenshot image file to be transmitted to the capture and replay verification module;

comparing, by the capture and replay verification module, an earlier captured screenshot image file with a later captured screenshot image file, so as to acquire a position to which a cursor moves, according to the mouse movement signal, on a screen of the system under test to which replay is applied; and

determining, by the capture and replay verification module according to the acquired position of the cursor on the screen, whether the cursor moves to a position corresponding to the designated image block or the specific cursor coordinate on the screen.

According to a second aspect of the present invention, a mouse action capture and replay system is provided, including:

a capture and replay verification module, configured to receive a keyboard signal or a mouse signal output by a keyboard or a mouse, and output the keyboard signal or the mouse signal to a system under test to which capture or replay is applied;

an image capture module, electrically connected to the capture and replay verification module and the system under test to which capture or replay is applied; and

a USB emulator, electrically connected to the capture and replay verification module and the system under test to which capture or replay is applied, where

the capture and replay verification module, the image capture module, and the USB emulator execute the method according to the first aspect of the present invention.

According to a third aspect of the present invention, a recording medium with an internally-stored program is provided, where after the program is loaded into the recording medium and is executed, a mouse action capture and replay system can complete the method according to the first aspect of the present invention.

According to a fourth aspect of the present invention, a program product with an internally-stored program is provided, where after the program is loaded into the program product and is executed, a mouse action capture and replay system can complete the method according to the first aspect of the present invention.

### BRIEF DESCRIPTION OF THE DRAWINGS

FIG. 1 is a block diagram of a mouse action capture and replay system according to the present invention;

FIG. 2 is a flowchart of a state of a mouse action capture mode according to the present invention;

FIG. 3A is a schematic diagram of an operation screen of mouse action capture and replay according to the present invention;

FIG. 3B is a schematic diagram of creating an event file in the operation screen according to the present invention;

FIG. 3C is a schematic diagram of creating an event file in a directory of the operation screen according to the present invention;

FIG. 4 is a schematic diagram of displaying an image of the system under test according to the present invention;

FIG. 5 is a schematic diagram of displaying an image of the system under test according to the present invention;

FIG. 6 is a schematic diagram of displaying a screen of content of the event file according to the present invention;

FIG. 7 is a schematic diagram of displaying an image of the system under test according to the present invention;

FIG. 8 is a flowchart of a state of a mouse action replay mode according to the present invention; and

FIG. 9 is a schematic diagram of displaying an execution table of mouse action replay on the operation screen according to the present invention.

### DETAILED DESCRIPTION

In order to make a person of ordinary skill in the art further understand the present invention, features and effects of the present invention are described in detail below through exemplary embodiments of the present invention with reference to the accompanying drawings. The present invention is also described in applicant's priority application, Application No. 105114284, filed with the Intellectual Property Office, Ministry of Economic Affairs, Republic of China, the entire contents of which are hereby incorporated herein by reference.

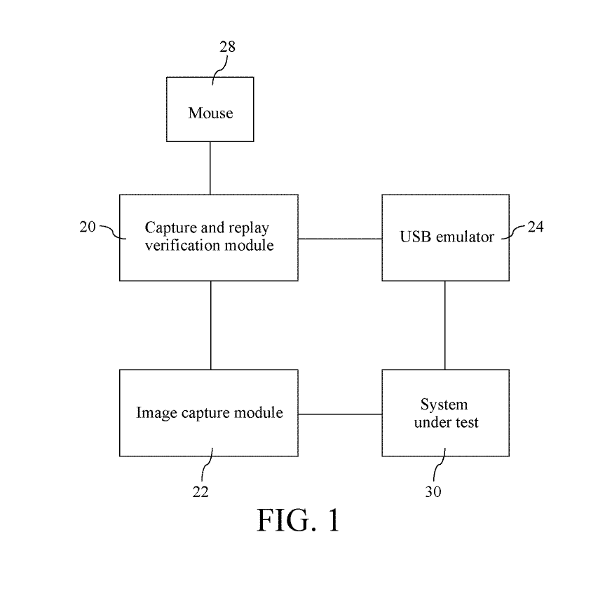

FIG. 1 is a block diagram of a mouse action capture and replay system according to the present invention. In FIG. 1, the mouse action capture and replay system includes a capture and replay verification module 20, an image capture module 22, and a USB emulator 24.

The capture and replay verification module 20 receives a mouse button signal (a signal generated by operating a left button, a right button, or a scroll wheel of the mouse) or a mouse movement signal output by a mouse 28. The image capture module 22 is electrically connected to the capture and replay verification module 20 and a system under test to which capture or replay is applied 30. The USB emulator 24 is electrically connected to the capture and replay verification module 20 and the system under test 30.

In a mouse action capture mode, the mouse 28 outputs the mouse button signal or the mouse movement signal to the capture and replay verification module 20; the capture and replay verification module 20 converts the received mouse movement signal to digital data (e.g. data of a coordinate position and a moving speed); the capture and replay verification module 20 stores the mouse button signal and the digital data converted from the mouse movement signal into a mouse action event file; the capture and replay verification module 20 transmits the mouse button signal or the mouse movement signal represented as the digital data to the USB emulator 24; and the USB emulator 24 converts the received digital data to the mouse movement signal, and outputs the mouse button signal or the mouse movement signal to the system under test 30, so as to perform an operation on the system under test 30.

The capture and replay verification module 20 regularly sends an image capture signal to the image capture module 22, for example, sends the image capture signal for five times in 1 second. The image capture module 22 captures, after receiving the image capture signal, an image displayed on a screen (not shown in the figures) of the system under test 30 to obtain a screenshot, and coverts the obtained screenshot to a screenshot image file to be transmitted to the capture and replay verification module 20.

In the mouse action capture mode, the capture and replay verification module 20 sends the image capture signal to the image capture module 22, and the image capture module 22 captures the screenshot from the system under test to which replay is applied 30 and converts the screenshot to the screenshot image file to be transmitted to the capture and replay verification module 20.

The capture and replay verification module 20 displays the screenshot corresponding to the screenshot image file. A test engineer circles a block that is used as a designated image block or a specific cursor coordinate on the screenshot, and writes the circled designated image block or the specific cursor coordinate into the mouse action event file.

After the circled designated image block or specific cursor coordinate is written into the mouse action event file, the capture and replay verification module 20 immediately moves the cursor on the screen of the system under test 30 to a position corresponding to the designated image block or the specific cursor coordinate, and executes a process of the mouse button signal on the system under test 30.

The capture and replay verification module 20 transmits, by using the USB emulator 24, the mouse movement signal to the system under test to which capture is applied 30. The cursor on the screen of the system under test to which capture is applied 30 moves according to the mouse movement signal. During a process that the cursor moves on the screen, the image capture module 22 continuously captures images displayed on the screen of the system under test 30 to obtain multiple screenshots, and converts the obtained multiple screenshots to multiple corresponding screenshot image files to be transmitted to the capture and replay verification module 20.

The capture and replay verification module 20 compares all the pixel values in an earlier captured screenshot image file with all the pixel values in a later captured screenshot image file. A pixel value corresponding to a background of the earlier captured screenshot image file is the same as a pixel value corresponding to the background of the later captured screenshot image file. A pixel value corresponding to a position of the cursor in the earlier screenshot image file is different from a pixel value corresponding to a position of the cursor after the movement in the later screenshot image file. Therefore, when the pixel values of the earlier screenshot image file is subtracted from the pixel values of the later screenshot image file, the backgrounds corresponding to the same pixel value in the earlier and later captured screenshot image files are eliminated, and the positions of the cursor before and after the movement corresponding to the different pixel values in the earlier and later captured screenshot image files are retained. The capture and replay verification module 20 performs calculation on the pixel values corresponding to the positions of the cursor before and after the movement to obtain data such as absolute position coordinates and the moving speed of the cursor on the screen, and stores the data.

When the capture and replay verification module 20 compares the earlier captured screenshot with the later captures screenshot to acquire that the cursor moves to the position corresponding to the designated image block or the specific cursor coordinate, the capture and replay verification module 20 transmits, by using the USB emulator 24, the mouse button signal in the mouse action event file to the system under test to which capture is applied 30, and the system under test to which capture is applied 30 executes the mouse button signal.

In a mouse action replay mode, the capture and replay verification module 20 transmits, by using the USB emulator 24, a mouse movement signal to the system under test to which replay is applied 30. The cursor on the screen of the system under test to which replay is applied 30 moves according to the mouse movement signal. During a process that the cursor moves on the screen, the image capture module 22 regularly and continuously captures images displayed on the screen of the system under test 30 to obtain multiple screenshots, and converts the obtained multiple screenshots to multiple corresponding screenshot image files to be transmitted to the capture and replay verification module 20.

The capture and replay verification module 20 compares all the pixel values in an earlier captured screenshot image file with all the pixel values in a later captured screenshot image file to obtain absolute coordinates of the cursor on the screen, and determines whether the position of the cursor on the screen is moved to a position of the designated image block or the specific cursor coordinate. The comparison manner is stated as above.

If the capture and replay verification module 20 determines that the cursor on the screen is not moved to the position of the designated image block or the specific cursor coordinate, the system under test to which replay is applied 30 enables, according to the mouse movement signal sent by the capture and replay verification module 20, the cursor to keep moving towards the position of the designated image block or the specific cursor coordinate on the screen. If the capture and replay verification module 20 determines that the cursor on the screen is moved to the position of the designated image block or the specific cursor coordinate, the capture and replay verification module 20 transmits, by using the USB emulator 24, a mouse button signal in the mouse action event file to the system under test to which replay is applied 30, so that the system under test 30 executes the mouse button signal.

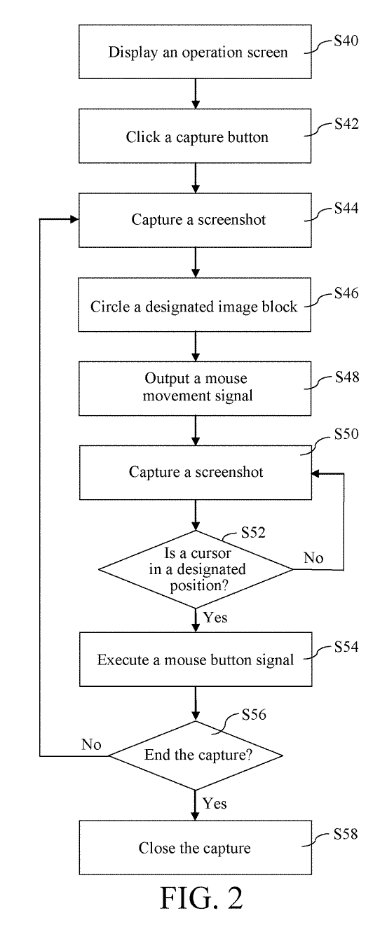

FIG. 2 is a flowchart of a mouse action capture mode according to the present invention. When the process steps of FIG. 2 are described, reference is made to the components of FIG. 1.

In a mouse action capture mode, a test engineer is enabled to operate a test case in the system under test to which capture is applied 30, the capture and replay verification module 20 captures a movement process of the cursor (corresponding to the mouse movement process) on the screen of the system under test to which capture is applied 30, so as to edit the movement process of the cursor into an operation case of a mouse action that is used as a reference of a future mouse operation for the system under test to which replay is applied 30.

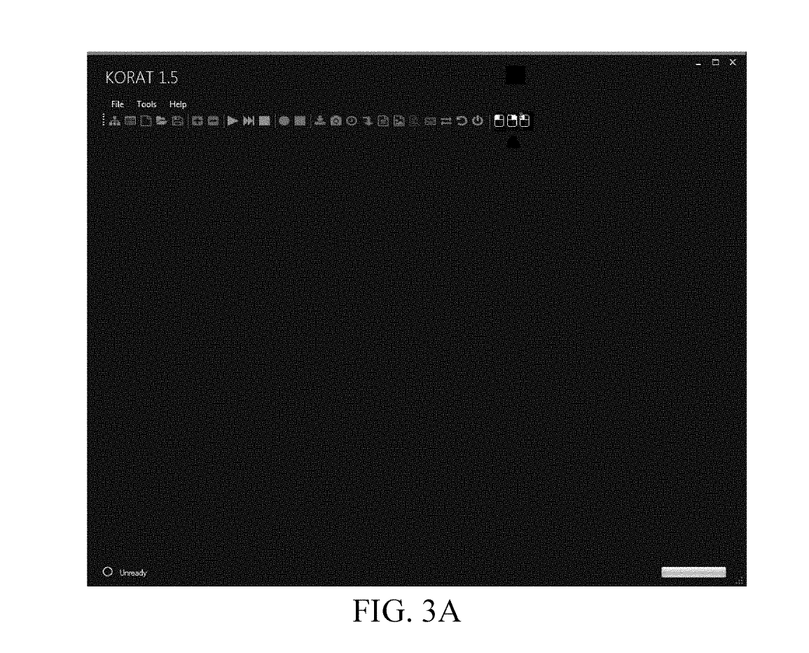

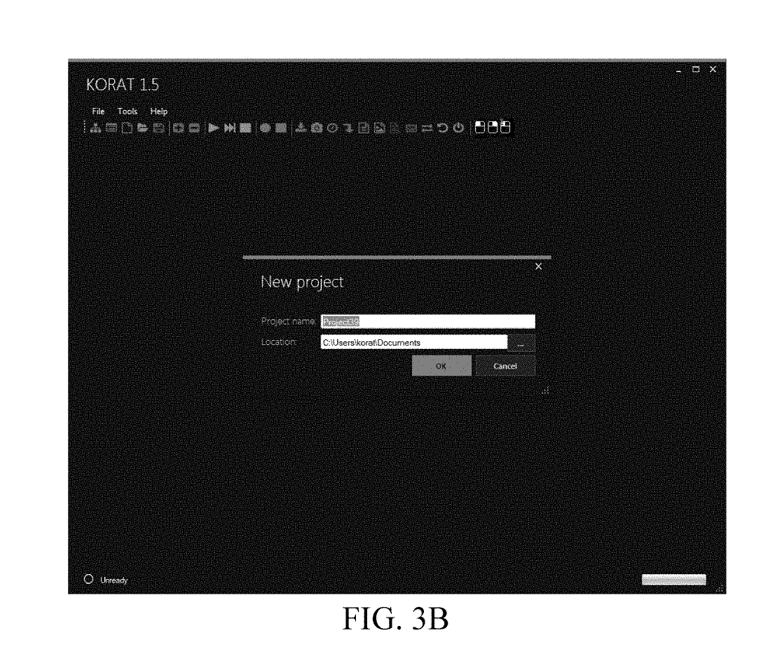

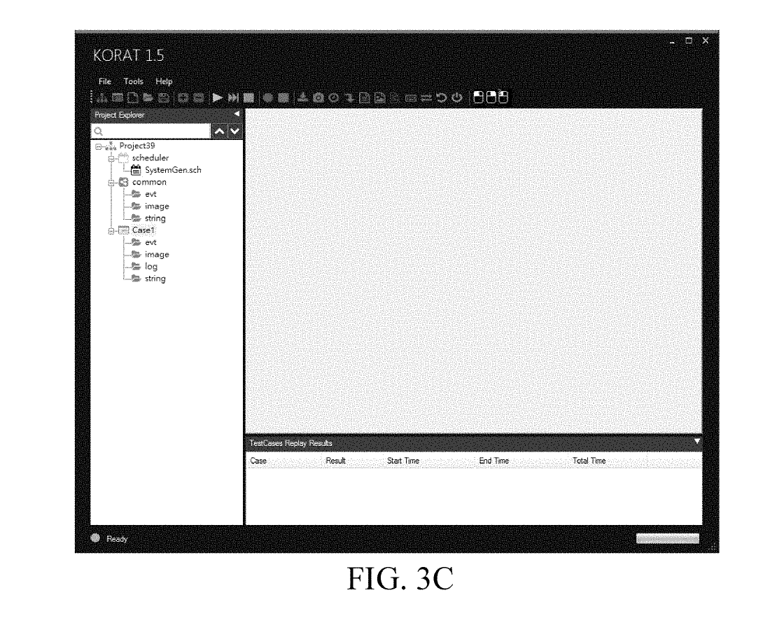

In FIG. 2, the capture and replay verification module 20 runs mouse action capture and replay software, and the screen (not shown in the figures) displays an operation screen (step S40), as shown in FIG. 3A, which is a schematic diagram of an operation screen of mouse action capture and replay according to the present invention. The test engineer creates a new event file in the operation screen, as shown in FIG. 3B, which is a schematic diagram of creating an event file in the operation screen according to the present invention, and creates an event file in a directory at a left side of the operation screen, as shown in FIG. 3C, which is a schematic diagram of creating an event file in a directory of the operation screen according to the present invention.

The test engineer clicks a capture button on the operation screen to generate a capture signal, and sends the capture signal to the capture and replay verification module 20 (step S42). At this time, the capture and replay verification module 20 sends an image capture signal to the image capture module 22, so that the image capture module 22 captures an image on the screen of the system under test to which capture is applied 30 to obtain a screenshot, and converts the screenshot to a screenshot image file to be transmitted to the capture and replay verification module 20 (step S44).

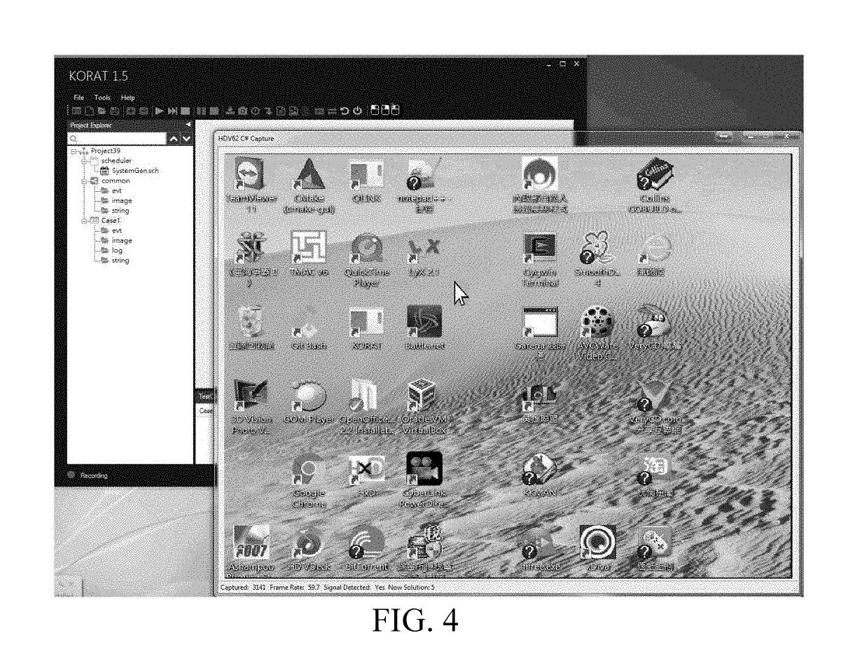

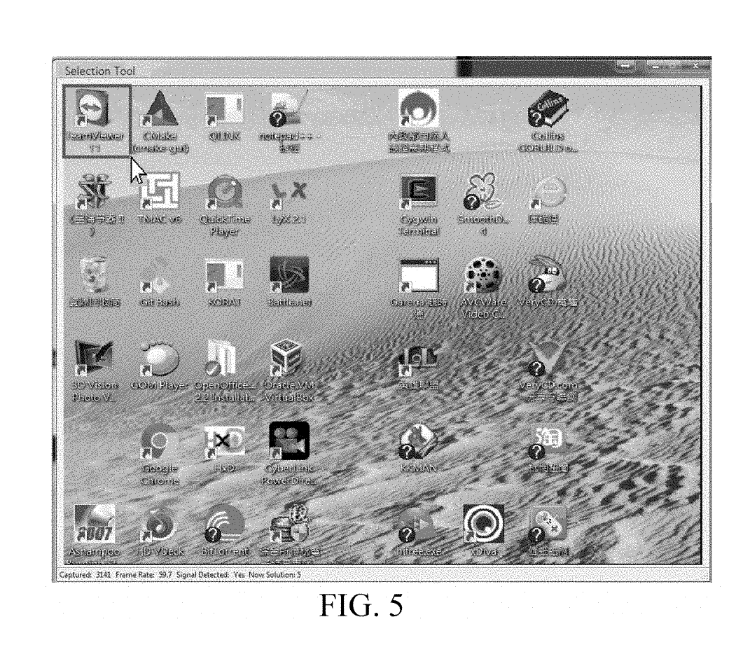

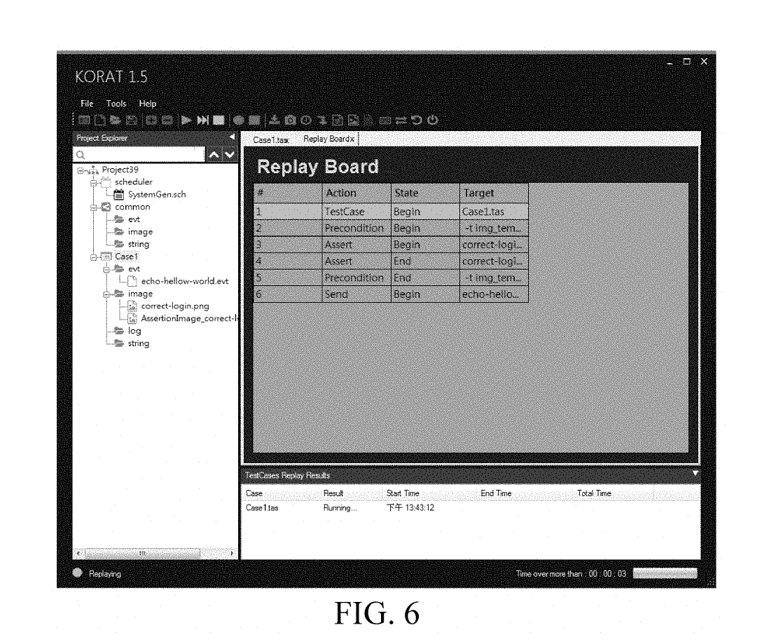

The capture and replay verification module 20 executes the screenshot image file, so as to enable the image on the screen of the system under test to which capture is applied 30 to overlap the operation screen, as shown in FIG. 4, which is a schematic diagram of displaying an image of the system under test according to the present invention. The test engineer circles, on the screenshot, a block that is used as the designated image block or the specific cursor coordinate, for example, circles an image “TeamViewer” in FIG. 5, which is a schematic diagram of displaying an image of the system under test, and writes the circled designated image block or specific cursor coordinate into the mouse action event file, and the capture and replay verification module 20 writes a mouse button signal corresponding to the circled designated image block or specific cursor coordinate into the mouse action event file (step S46), so that the mouse action event file is used as a test script of the system under test to which replay is applied 30, as shown in FIG. 6, which is a schematic diagram of displaying a screen of content of the event file according to the present invention.

After the circled designated image block or specific cursor coordinate is written into the mouse action event file, the capture and replay verification module 20 immediately moves the cursor on the screen of the system under test 30 to a position corresponding to the designated image block or the specific cursor coordinate, and executes a process of the mouse button signal on the system under test 30.

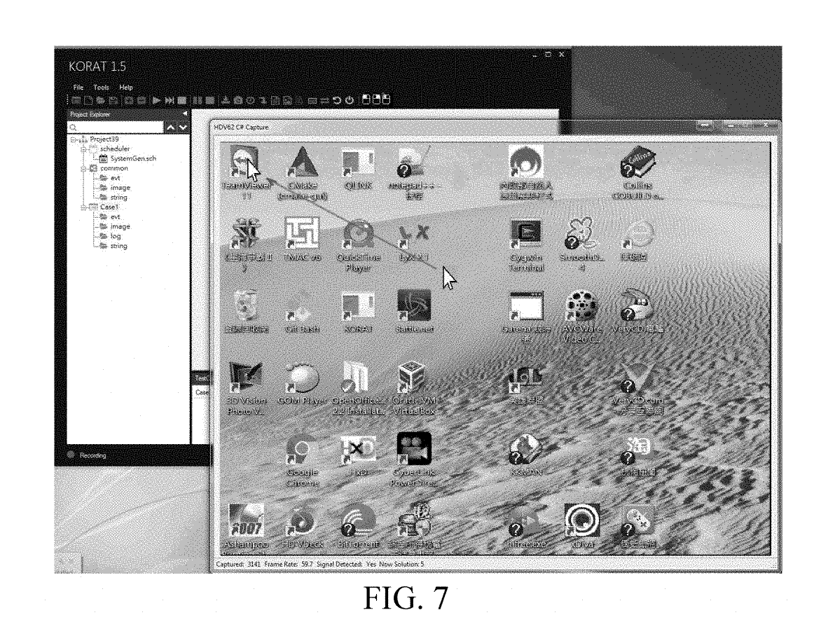

The capture and replay verification module 20 transmits digital data corresponding to the mouse movement signal to the USB emulator 24. The USB emulator 24 further converts the received digital data to the mouse movement signal, and outputs the signal to the system under test to which capture is applied 30, so as to enable the cursor on the screen to move, according to the mouse movement signal, towards the position corresponding to the designated image block or the specific cursor coordinate on the screen (step S48), as shown in FIG. 7, which is a schematic diagram of displaying an image of the system under test, the cursor moves from a position slightly deviating from the middle of the screen towards an upper left corner to the position of the image “TeamViewer”.

During a process that the cursor moves from the position slightly deviating from the middle of the screen towards the upper left corner to the position of the image “TeamViewer”, the capture and replay verification module 20 regularly sends an image capture signal to the image capture module 22, and the image capture module 22 captures, after receiving the image capture signal, an image displayed on the screen of the system under test 30 to obtain a screenshot, and converts the obtained screenshot to a screenshot image file to be transmitted to the capture and replay verification module 20 (step S50). During a process that the cursor moves on the screen, the image capture module 22 continuously captures images displayed on the screen of the system under test 30 to obtain multiple screenshots, and converts the obtained multiple screenshots to multiple corresponding screenshot image files to be transmitted to the capture and replay verification module 20.

The capture and replay verification module 20 compares all the pixel values in an earlier captured screenshot image file with all the pixel values in a later captured screenshot image file. When the pixel values of the earlier screenshot image file is subtracted from the pixel values of the later screenshot image file, the backgrounds corresponding to the same pixel value in the earlier and later captured screenshot image files are eliminated, and the positions of the cursor before and after the movement corresponding to the different pixel values in the earlier and later captured screenshot image files are retained. The capture and replay verification module 20 performs calculation on the pixel values corresponding to the positions of the cursor before and after the movement to obtain data such as absolute position coordinates and the moving speed of the cursor on the screen, and stores the data.

The capture and replay verification module 20 compares all the pixel values in the earlier captured screenshot image file with all the pixel values in the later captured screenshot image file to obtain absolute coordinates of the cursor on the screen, and determines whether the position of the cursor on the screen is moved to a position of the designated image block (e.g. the image “TeamViewer” in FIG. 7) or the specific cursor coordinate on the screen (step S52).

If the capture and replay verification module 20 determines that the cursor on the screen is not moved to the position of the designated image block (e.g. the image “TeamViewer” in FIG. 7) or the specific cursor coordinate, implement step S50, that is, the system under test to which replay is applied 30 enables, according to the mouse movement signal sent by the capture and replay verification module 20, the cursor to keep moving towards the position of the designated image block or the specific cursor coordinate on the screen. If the capture and replay verification module 20 determines that the cursor on the screen is moved to the position of the designated image block or the specific cursor coordinate, the capture and replay verification module 20 transmits, by using the USB emulator 24, a mouse button signal to the system under test to which capture is applied 30, so that the system under test 30 executes the mouse button signal (step S54).

Then, the test engineer determines whether capture of the mouse action event file of the system under test to which capture is applied 30 is completed or not (step S56). If the capture of the mouse action event file of the system under test to which capture is applied 30 is not completed, implement S44, that is, continue capturing the test script of the mouse action event file. If the capture of the mouse action event file of the system under test to which capture is applied 30 is completed, the test engineer closes a capture function of the capture button on the operation screen (step S58).

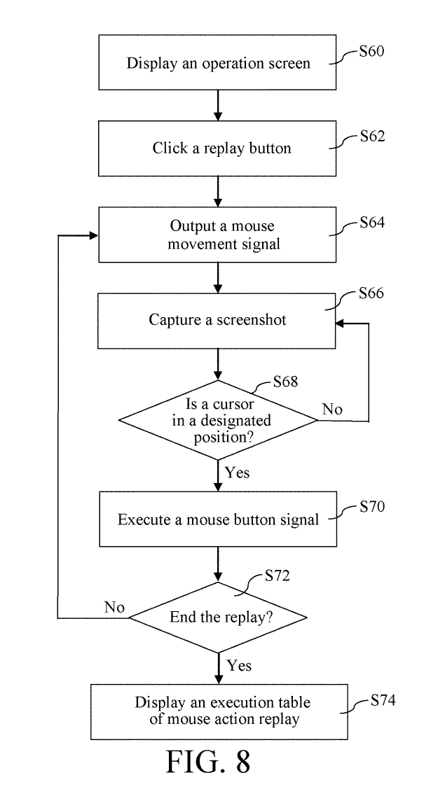

FIG. 8 is a flowchart of a mouse action replay mode according to the present invention. When the process steps of FIG. 8 are described, reference is made to the components of FIG. 1.

In the mouse action replay mode, a test engineer enables an event file of an operation captured in a capture mode to be automatically executed on a system under test to which replay is applied 30, so that the test engineer does not need to manually operate the mouse 28 repeatedly, thereby reducing a lot of labor and saving a lot of time.

In FIG. 8, the capture and replay verification module 20 runs mouse action capture and replay software, and an screen (not shown in the figures) displays an operation screen (step S60), as shown in FIG. 3A.

The test engineer clicks a replay button on the operation screen to generate a replay signal, and sends the replay signal to the capture and replay verification module 20, and the capture and replay verification module 20 reads a mouse button signal and a designated image block or a specific cursor coordinate in a mouse action event file, as shown in FIG. 6, and displays data in the mouse action event file on the operation screen (step S62).

Then, the capture and replay verification module 20 transmits, by using the USB emulator 24, a mouse movement signal to the system under test to which replay is applied 30, so as to enable a cursor on the screen of the system under test to which replay is applied 30 to move according to the mouse movement signal (step S64).

During a process that the cursor moves on the screen, the image capture module 22 regularly and continuously captures images displayed on the screen of the system under test 30 to obtain multiple screenshots, and converts the obtained multiple screenshots to multiple corresponding screenshot image files to be transmitted to the capture and replay verification module 20 (step S66).

The capture and replay verification module 20 compares all the pixel values in an earlier captured screenshot image file with all the pixel values in a later captured screenshot image file to obtain absolute coordinates of the cursor on the screen, and determines whether the position of the cursor on the screen is moved to a position corresponding to the designated image block or the specific cursor coordinate (step S68).

If the capture and replay verification module 20 determines that the cursor on the screen is not moved to the position of the designated image block or the specific cursor coordinate, implement step S66, that is, the system under test to which replay is applied 30 enables, according to the mouse movement signal sent by the capture and replay verification module 20, the cursor to keep moving towards the position of the designated image block or the specific cursor coordinate on the screen. If the capture and replay verification module 20 determines that the cursor on the screen is moved to the position of the designated image block or the specific cursor coordinate, the capture and replay verification module 20 transmits, by using the USB emulator 24, a mouse button signal in the mouse action event file to the system under test to which replay is applied 30, so that the system under test 30 executes the mouse button signal (step S70).

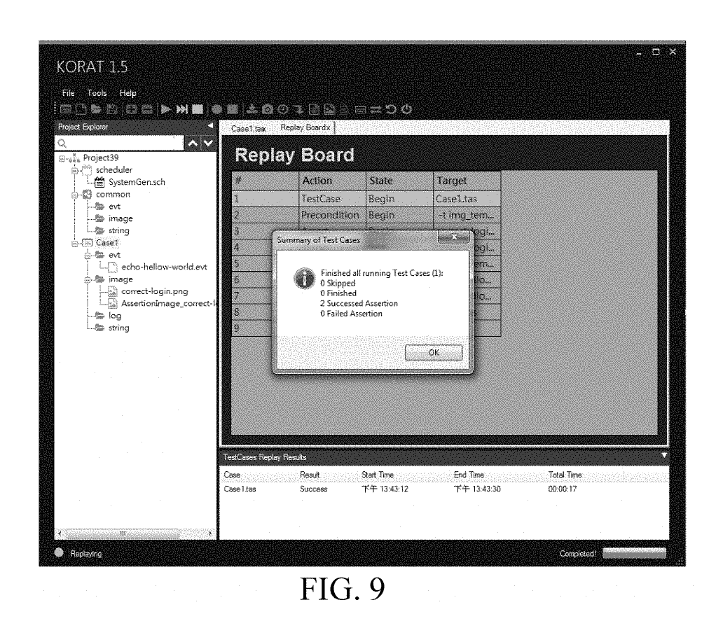

Then, the capture and replay verification module 20 determines whether the mouse button signal and the designated image block or the specific cursor coordinate that are used as test scripts in the mouse action event file are completely output to the system under test to which replay is applied 30 (step S72). If the test scripts in the mouse action event file are not completely output to the system under test to which replay is applied 30, implement step S64. If the test scripts in the mouse action event file are completely output to the system under test to which replay is applied 30, the capture and replay verification module 20 closes a replay function and displays an execution table of mouse action replay on the operation screen, so as to enable the test engineer to view a test result of the system under test to which replay is applied 30 (step S74), as shown in FIG. 9, which is a schematic diagram of displaying an execution table of mouse action replay on the operation screen according to the present invention.

The foregoing mouse action capture and replay method of the present invention can be implemented by using a program pattern, and the program can be stored in a recording medium. After the program is loaded into the recording medium and is executed, a mouse action capture and replay system can complete the method steps shown in the foregoing description and drawings.

Likewise, the foregoing mouse action capture and replay method of the present invention can be implemented by using a program product. After downloading the program product from a network, for example, and executing the program product, a mouse action capture and replay system can complete the method steps shown in the foregoing description and drawings.

The present invention provides a mouse action capture and replay system and method, a recording medium, and a program product. With the present invention, no mouse event blocking software needs to be installed on a system under test; by means of capture and replay technologies, a test engineer can capture a whole mouse operation action to form an event file, and mouse operation actions are executed one by one, in a manner of replaying data of the mouse operation actions in the event file, on the system under test; and a tester does not need to manually operate the mouse step by step, so as to achieve the objective of automation and the objective of simultaneously testing multiple computers.

Although the present invention has been described above with reference to the exemplary embodiments and exemplary drawings, the exemplary embodiments and exemplary drawings should not be regarded as a limitation. Various modifications, omissions, and variations that are made by a person skilled in the art on the form and embodiments of the present invention do not depart from the scope claimed by the present invention.

What is claimed is:

1. A mouse action capture and replay method, comprising the following steps:
reading, by a capture and replay verification module, a mouse action event file, wherein the mouse action event file comprises a designated image block or a specific cursor coordinate;
transmitting, by the capture and replay verification module by using a Universal Serial Bus (USB) emulator, a mouse movement signal to a system under test to which replay is applied;
regularly sending, by the capture and replay verification module, an image capture signal to an image capture module, capturing, by the image capture module, a screenshot from the system under test to which replay is applied, and converting the screenshot to a screenshot image file to be transmitted to the capture and replay verification module;
comparing, by the capture and replay verification module, an earlier captured screenshot image file with a later captured screenshot image file, so as to acquire a position to which a cursor moves, according to the mouse movement signal, on a screen of the system under test to which replay is applied; and
determining, by the capture and replay verification module according to the acquired position of the cursor on the screen, whether the cursor moves to a position corresponding to the designated image block or the specific cursor coordinate on the screen.

2. The method according to claim 1, wherein after the step of determining, by the capture and replay verification module, whether the cursor moves to a position corresponding to the designated image block or the specific cursor coordinate on the screen, the method comprises the following steps:
if the cursor does not move to the position corresponding to the designated image block or the specific cursor coordinate on the screen, repeatedly performing the steps of claim 1; and
if the cursor moves to the position corresponding to the designated image block or the specific cursor coordinate on the screen, reading, by the capture and replay verification module, a mouse button signal in the mouse action event file, transmitting, by using the USB emulator, the mouse button signal to the system under test to which replay is applied, and executing, by the system under test to which replay is applied, the mouse button signal.

3. The method according to claim 1, wherein before the step of reading, by a capture and replay verification module, a mouse action event file, the method comprises the following steps:
sending, by the capture and replay verification module, the image capture signal to the image capture module, capturing, by the image capture module, the screenshot from a system under test to which capture is applied, and converting the screenshot to the screenshot image file to be transmitted to the capture and replay verification module;
displaying, by the capture and replay verification module, the screenshot corresponding to the screenshot image file, circling a block that is used as the designated image block or the specific cursor coordinate on the screenshot, and writing the circled designated image block or the specific cursor coordinate into the mouse action event file;
transmitting, by the capture and replay verification module by using the USB emulator, the mouse movement signal to the system under test to which capture is applied;
regularly sending, by the capture and replay verification module, the image capture signal to the image capture module, capturing, by the image capture module, the screenshot from the system under test to which capture is applied, and converting the screenshot to the screenshot image file to be transmitted to the capture and replay verification module;
comparing, by the capture and replay verification module, the earlier captured screenshot image file with the later captured screenshot image file, so as to acquire the position to which the cursor moves, according to the mouse movement signal, on the screen;
if the cursor moves to the position corresponding to the designated image block or the specific cursor coordinate on the screen, transmitting, by the capture and replay verification module by using the USB emulator, a mouse button signal in the mouse action event file to the system under test to which capture is applied, and executing, by the system under test to which replay is applied, the mouse button signal; and
determining whether to end a program of capturing a mouse action, so as to decide whether to end or perform the foregoing steps again.

4. The method according to claim 3, wherein the capture and replay verification module compares all the pixel values in the earlier captured screenshot image file with all the pixel values in the later captured screenshot image file.

5. A mouse action capture and replay system, comprising:
a capture and replay verification module, configured to receive a mouse button signal or a mouse movement signal output by a mouse, and output the mouse button signal or the mouse movement signal to a system under test to which capture or replay is applied;
an image capture module, electrically connected to the capture and replay verification module and the system under test to which capture or replay is applied; and
a USB emulator, electrically connected to the capture and replay verification module and the system under test to which capture or replay is applied,
wherein the capture and replay verification module, the image capture module, and the USB emulator execute the method of claim 1.

6. A recording medium with an internally-stored program, wherein after the program is loaded into the recording medium and is executed, a mouse action capture and replay system can complete the method of claim 1.

7. A program product with an internally-stored program, wherein after the program is loaded into the program product and is executed, a mouse action capture and replay system can complete the method of claim 1.

8. A mouse action capture and replay system according to claim 5, wherein the capture and replay verification module, the image capture module, and the USB emulator execute the method of claim 2.

9. A mouse action capture and replay system according to claim 5, wherein the capture and replay verification module, the image capture module, and the USB emulator execute the method of claim 3.

10. A mouse action capture and replay system according to claim 5, wherein the capture and replay verification module, the image capture module, and the USB emulator execute the method of claim 4.

11. A recording medium with an internally-stored program according to claim 6, wherein the mouse action capture and replay system can complete the method of claim 2.

12. A recording medium with an internally-stored program according to claim 6, wherein the mouse action capture and replay system can complete the method of claim 3.

13. A recording medium with an internally-stored program according to claim 6, wherein the mouse action capture and replay system can complete the method of claim 4.

14. A program product with an internally-stored program according to claim 7, wherein the mouse action capture and replay system can complete the method of claim 2.

15. A program product with an internally-stored program according to claim 7, wherein the mouse action capture and replay system can complete the method of claim 3.

16. A program product with an internally-stored program according to claim 7, wherein the mouse action capture and replay system can complete the method of claim 4.
